(19) United States
(12) Patent Application Publication
(10) Pub. No.: US 2002/0077760 A1
(43) Pub. Date: Jun. 20, 2002

(54) SOLAR BATTERY

(76) Inventor: W. PARKE COLE, VENTURA, CA (US)

Correspondence Address: JON E. HOKANSON, SMALL LARKIN, LLP, 10940 WILSHIRE BOULEVARD, EIGHTEENTH FLOOR, LOS ANGELES, CA, 90024, US

(21) Appl. No.: 09/405,734

(22) Filed: Sep. 24, 1999

(51) Int. Cl. G06F 19/00

(52) U.S. Cl. 702/63

(57) ABSTRACT

A method and apparatus for a solar battery is disclosed. The solar battery consists of a micro-solar array and battery for providing power to a load device. The micro-solar array and battery are connected to a micro-controller having memory for repetitively executing a sequence of program instructions for implementing solar battery management logic. The solar battery management logic efficiently charges and discharges the battery and keeps the battery history in the event there is no power available from the battery or the micro-solar array.

### BACKGROUND OF THE INVENTION

1. Technical Field

The present invention relates to an improved solar battery for efficiently providing power to a load device and more particularly to a solar battery implementing battery management logic for efficiently charging and discharging a battery.

2. Description of the Prior Art

As electronic devices are integrated into smaller portable packages, there is an increasing need for a battery power source that can allow a practical operation period of the device. In most cases, economics require such batteries to be rechargeable. Unfortunately, the technology concerned with energy density of such power sources has not kept pace with electronics integration technology. This has resulted in the now common situation where the battery constitutes a major portion of the volume and weight of a given system, examples of which are cellular phones and portable computers.

A solution, in part, lies not in a breakthrough battery chemistry, but in understanding of the paradigm which dictates that batteries must last as long as possible. By use of a micro-solar array and battery management logic, the period required for charging the battery may be significantly extended. The present invention therefore utilizes the combination of a micro-solar array, battery and battery management logic to solve this problem in a new and unique manner not previously known in the arts.

### SUMMARY OF THE INVENTION

In view of the foregoing, it is therefore one object of the present invention to provide an improved solar battery for efficiently providing power to a load device.

It is another object of the present invention to provide a solar battery implementing battery management logic for efficiently charging and discharging a battery.

A method and apparatus for a solar battery is disclosed. The solar battery consists of a micro-solar array and battery for providing power to a load device. The micro-solar array and battery are connected to a micro-controller having memory for repetitively executing a sequence of program instructions for implementing solar battery management logic. The solar battery management logic efficiently charges and discharges the battery and keeps the battery history in the event there is no power available from the battery or the micro-solar array.

All objects, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a block diagram of a solar battery in accordance with the present invention;

FIG. 2 is a detailed block diagram of the microprocessor of FIG. 1 in accordance with the present invention;

FIG. 3 is a flowchart showing the steps of the solar battery of FIG. 1 going into stasis;

FIG. 4 is a flowchart showing the steps of the solar battery of FIG. 1 coming out of stasis;

FIG. 5 is a flowchart showing the steps of delivering power when a load device is present;

FIG. 6 is a flowchart showing the steps of charging a battery utilizing the micro-solar array of FIG. 1; and

FIG. 7 is a flowchart showing the steps of charging a battery when an external charger is present.

### DETAILED DESCRIPTION OF A PREFERRED EMBODIMENT

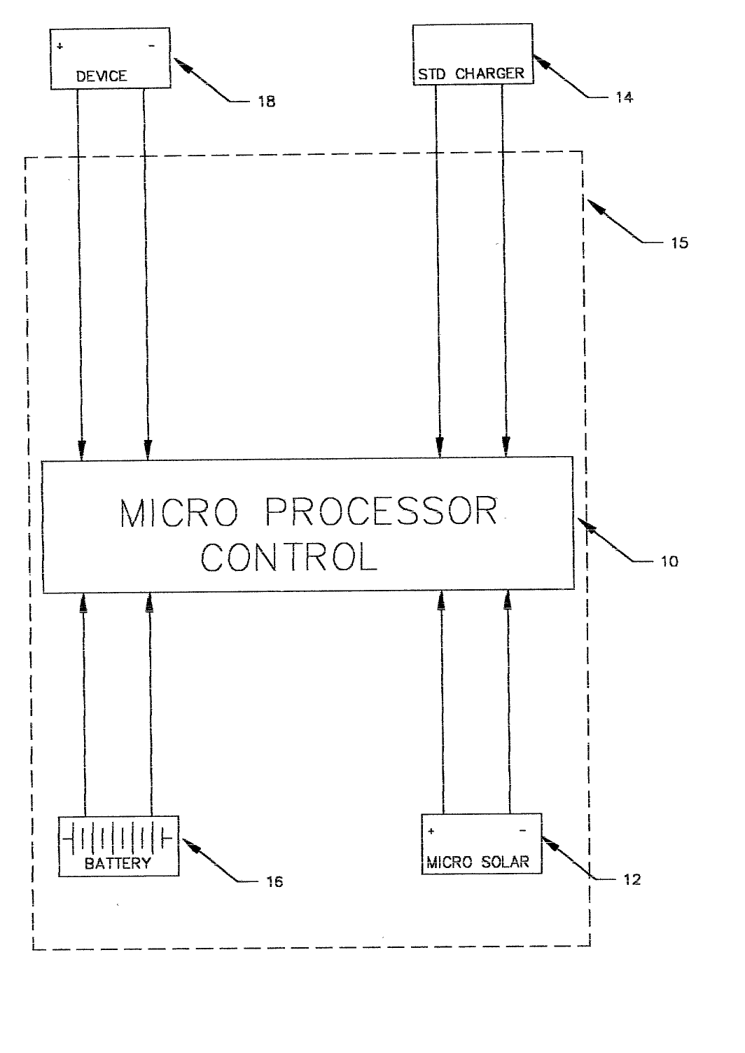

Referring now to the drawings wherein like reference numerals refer to like and corresponding parts throughout, FIG. 1 shows a block diagram of the solar battery 15 in accordance with the present invention. Referring to FIG. 1, The solar battery consists of a micro-solar array 12 and battery 16 connected to a microprocessor 10 for providing and controlling power to a load device 18. Although, not part of the present invention, an external charger 14 is also shown to charge the battery 16. It should also be understood that the load device 18 is not part of the solar battery 15, as shown in FIG. 1. The microprocessor 10 contains solar battery management logic for efficiently charging and discharging the battery 16. The microprocessor 10 also monitors power availability from the solar battery 15 portion consisting of either the micro-solar array 12 and the battery 16 or both. Additionally, the microprocessor 10 repetitively executes a sequence of program instructions for implementing solar battery management, as will be more fully described below.

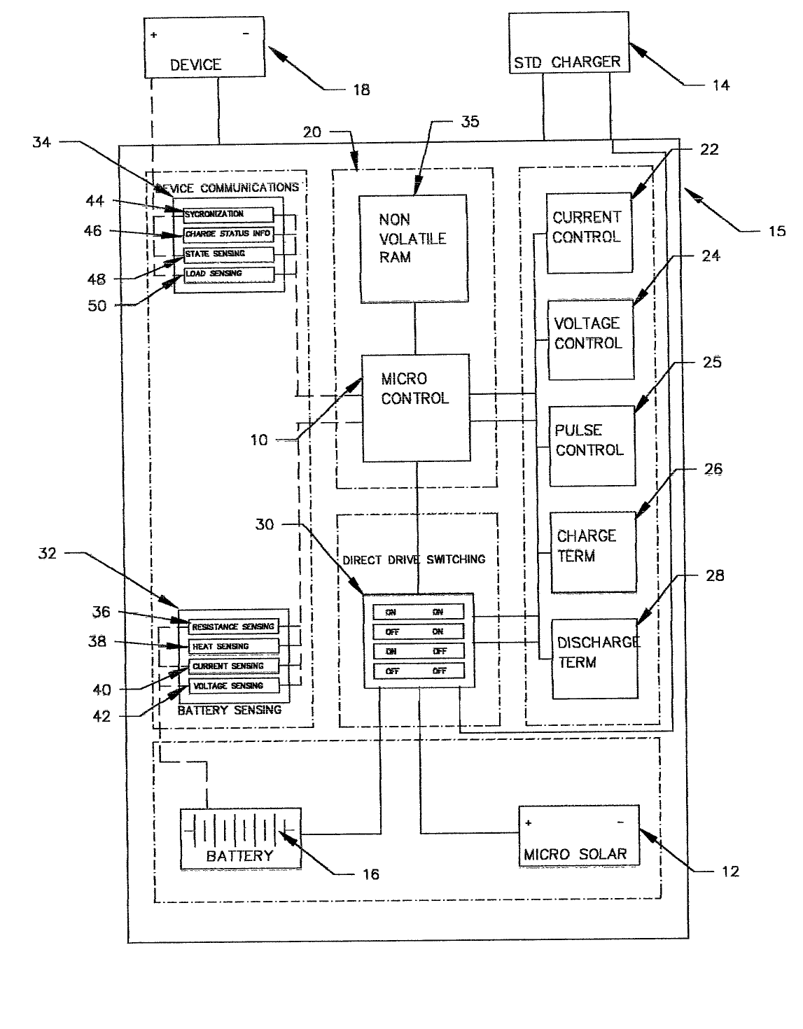

Referring now to FIG. 2, there is shown the details of the microprocessor 10 of FIG. 1. As shown, by FIG. 2, the microprocessor 10 includes a battery-sensing portion 32 that continuously receives information about the battery charge and discharge condition and information about the chemistry of the battery 16. More particularly, the battery-sensing portion 32 senses the parameters of resistance 36, temperature or heat 38, current 40 and voltage 42 of the battery 16, all used in either charging or discharging the battery 16. Turning once again to FIG. 2, the microprocessor 10 also includes a device communications portion 34 that continuously receives information about the load device 18. More particularly, the device communications portion 34 senses the parameters of synchronization 44, charge status 46, state 48 and load 50 requirements of the load device 18 for delivering power to the load device 18.

The inputs from both the device-communications portion 34 and battery-sensing portion 32 are placed in non volatile ram 35 of the micro-control 20 portion of the microprocessor 10 for use by the battery management logic. Referring once again to FIG. 2, the battery management logic consists of five components, more particularly, current control 22, voltage control 24, pulse control 25, charge term 26 and discharge term 28. By using these five components and the sensing information stored in the non volatile ram 35 of the micro-control 20 portion, the battery management logic provides power to the device 18 based on its exact needs from either the micro-solar array 12, the battery 16, or both, by use of drive switching logic 30. Similarly, with the five components and the sensing information stored in the non volatile ram 35 of the micro-control 20 portion, the battery management logic provides exact charging when a charger 14 is present to the battery 16 through the non volatile ram 35 of drive switching logic 30. The battery management logic has stored in the non volatile ram 35 of memory of the micro-control 20 portion a predetermined load demand for a specific load device 18 for determining power availability from both the micro-solar array 12 and the battery 16. This parameter establishes the physical size of the micro-solar array 12 and the charge size of the battery 16 for a given load device 18.

As described above, the micro-control 20 portion continuously obtains and stores the charge and discharge information for the battery 16 as well as the number of cycles or times the battery has been fully charged. This allows the battery the greatest amount of life over its use. The microprocessor 10 also conducts a variety of tests for providing the exact amount of charge to the battery 16. A pulse resistance test is used to sense a current level and a pulse capacitance test for sensing the voltage of the battery 16 are used for providing a charging current. Also, a recognized charge rate for the battery 16 at predetermined intervals are used as well as the batteries temperature to select a charge path having a pulse cap set-up and alternating discharge mode. Lastly, power is provided to the load device 18 by pegging voltage throughout the load device 18 in response to a constant signaling from the load device 18.

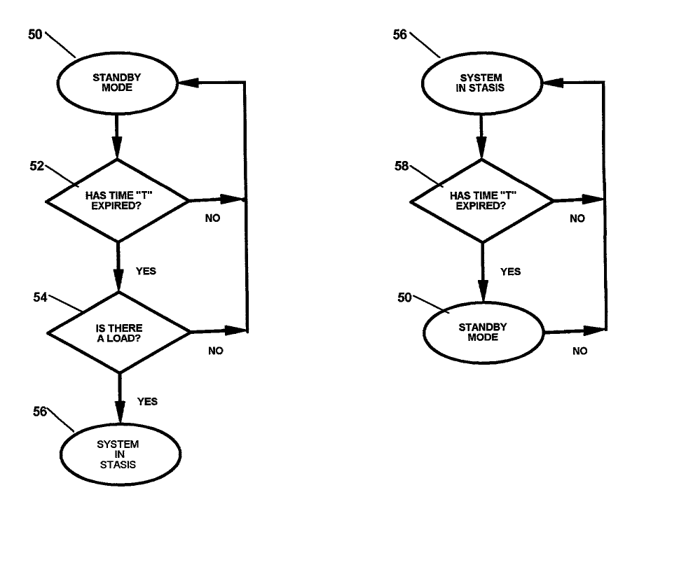

Referring to FIG. 3, there is shown a flowchart depicting the steps for the condition when the solar battery 15 of the present invention goes into stasis. As shown in FIG. 3, the microprocessor 10 when no activity is present is in a standby mode in step 50 and checks to see if a time “T” has expired in a continuous loop from step 52 to step 50. When time “T” has expired in step 52 the microprocessor 10 checks the condition in step 54 whether the available power has dropped below a threshold for operating the microprocessor 10. If power is available and has not dropped below the threshold, the microprocessor 10 returns to step 50 in standby mode and the cycle begins again. The available power would be from the micro-solar array 12, the battery 16, or both. When the power drops below the operating threshold the microprocessor 10 goes into stasis or a sleep state as shown in step 56. When in stasis, the battery history is placed in non-volatile ram 35, as shown in FIG. 2, that protects any loss of the battery history when no power is available from any source.

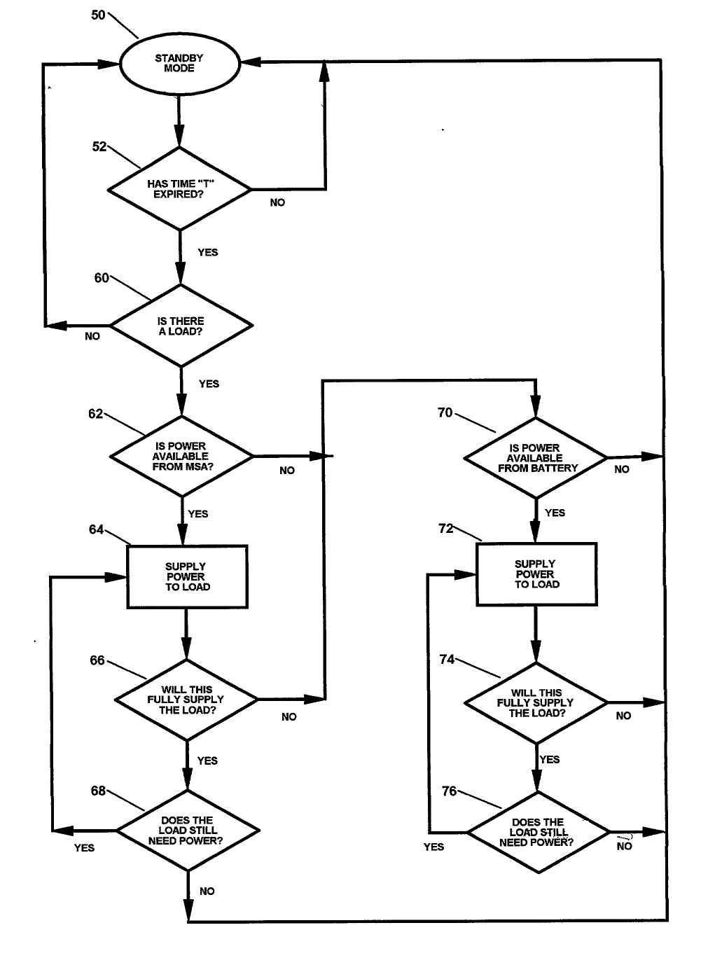

Referring now to FIG. 4, there is shown a flowchart depicting the steps for the condition when the solar battery 15 of the present invention comes out of stasis. As described-above, when the system is in stasis in step 56, no loss of the battery history occurs. A unique novelty of the present invention is its ability never to lose the battery history which results in the battery management logic when active always providing the best charge possible to the battery 16 based on continuously having the battery history. Turning once again to FIG. 4, when power is available from any source in step 58 whether from the micro-solar array 12 itself, from the battery 16 or from an external charger being present 14, the microprocessor 10 comes out of stasis and into standby mode in step 50 with the battery history to date completely intact. Therefore, in step 58, until a power source becomes available above the threshold, the microprocessor stays in stasis in step 56.

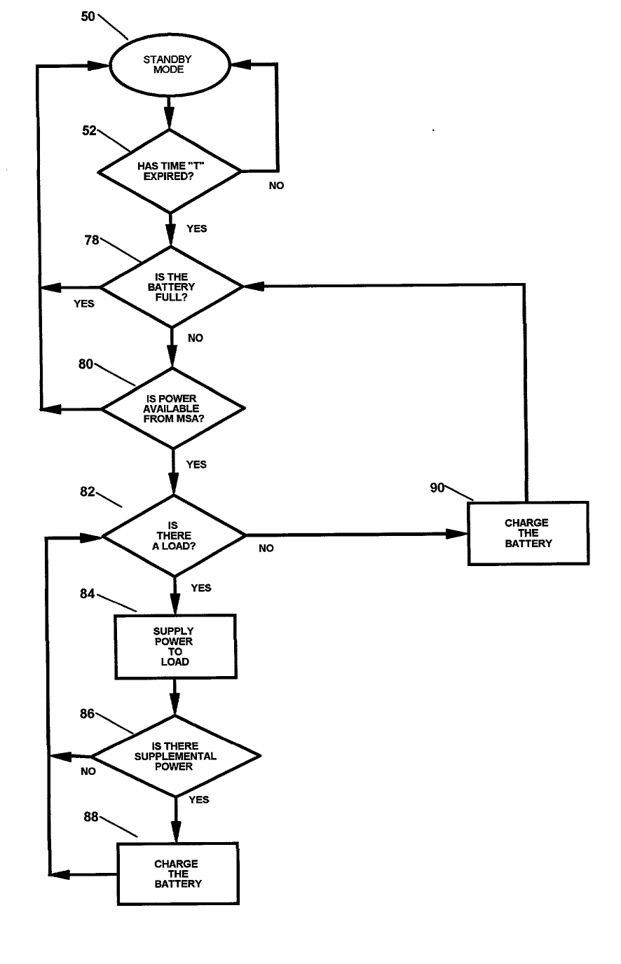

Referring now to the flowchart of FIG. 5, there is shown a flowchart depicting the steps used for the sequence of programming instructions which may be used for the battery management logic in accordance with one preferred embodiment of the invention. As shown in FIG. 5, the microprocessor 10 when no activity is present is in a standby mode in step 50 and checks to see if a time “T” has expired in a continuous loop from step 52 to step 50. When time “T” has expired in step 52 the microprocessor 10 checks the condition in step 60 whether there is a load device 18 present. If no load device 18 is present, the microprocessor 10 returns to step 50 in standby mode and the cycle begins again. If a load device 18 is present in step 60, the sequence proceeds to step 62 wherein the micro-solar array is checked to determine if power is available (i.e. enough light is available) to supply the load device 18. If power is available, the power from the micro-solar array 12 is supplied to the load in step 64. The battery management logic in accordance with the present invention next checks to see if the available power in step 66 will full supply the load and if so proceeds to check in step 68 if the load device 18 still needs power. If the load device 18 still needs power, the sequence returns to step 64 and the process loops again through steps 64, 66 and 68.

Referring once again to FIG. 5, if in step 62 the available power is not available from the micro-solar array 12, the sequence proceeds to step 70 and the battery management logic determines if there is power available from the battery 16. Similarly, if in step 66 the micro-solar array 12 cannot fully supply the load device 18 the sequence proceeds to step 70 and the battery management logic determines if there is power available from the battery 16. If power is available in step 70, the power from the battery 16 is supplied to the load in step 72. The battery management logic in accordance with the present invention next checks to see if the available power in step 74 from the battery 16 and the micro-solar array 12 will fully supply the load and if so proceeds to check in step 76 if the load device 18 still needs power. If the load device 18 still needs power, the sequence returns to step 72 and the process loops again through steps 72, 74 and 76. If no power is available from the battery 16 in step 70 or if the battery alone or in combination with the micro-solar array 12 will not fully supply the load in step 74, the microprocessor 10 returns the solar battery 15 to standby mode. Lastly, if the load device 18 is removed, then in step 68 and/or 76 the load device does not require power and the microprocessor 10 returns the solar battery 15 to standby mode 50.

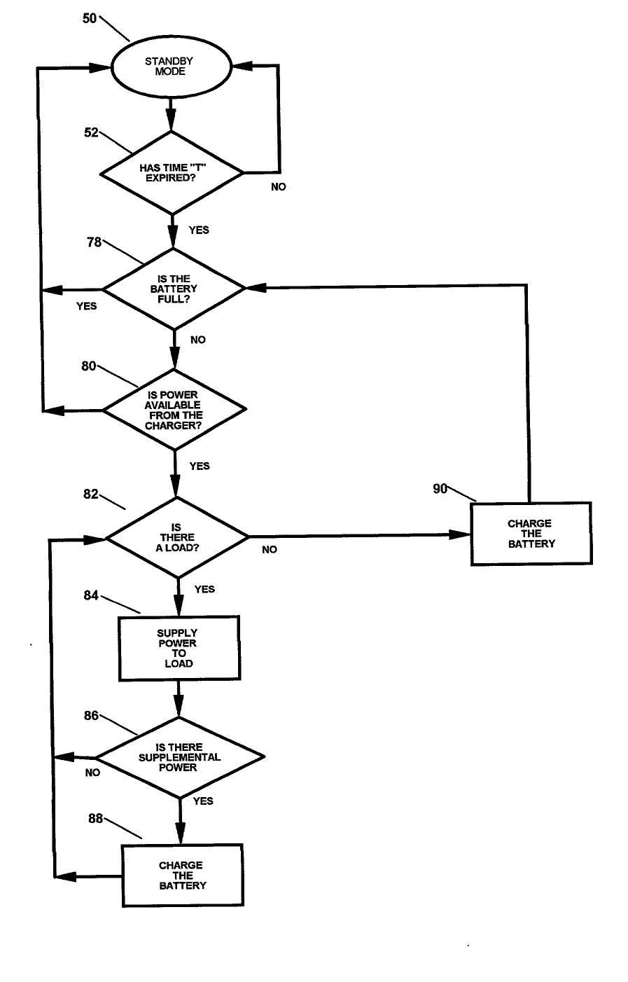

Referring now to FIG. 6, there is shown a flowchart depicting the steps used for the sequence of programming instructions which may be used for charging the battery utilizing the micro-solar array 12 in accordance with one preferred embodiment of the invention. As shown in FIG. 6, the microprocessor 10 when no activity is present is in a standby mode in step 50 and checks to see if a time “T” has expired in a continuous loop from step 52 to step 50. When time “T” has expired in step 52 the microprocessor 10 checks the condition in step 78 whether the battery 16 is fully charged. If the battery is fully charged, the microprocessor 10 returns to step 50 in standby mode and the cycle begins again. If in step 78, the battery is not full the sequence proceeds to step 80 wherein the battery management logic determines if power is available from the micro-solar array 12 in step 80. If no power is available, the microprocessor 10 returns to standby mode in step 50 and the process begins again.

Referring once again to FIG. 6, if there is power available from the micro-solar array 12 in step 80, the sequence proceeds to step 82 wherein the microprocessor 10 checks to see if there is a load device 18 present. If no load device 18 is present, the battery 16 is charged in step 90 by the micro-solar array 12 and the sequence proceeds to step 78 and loops through steps 78, 80, 82 and 90 until the battery 16 is fully charged or power is no longer available for charging from the micro-solar array 12. If there is a load in step 82, the micro-solar array 12 supplies power to the load device 18 in step 84 and the microprocessor 10 determines in step 86 if there is any supplemental power available. If there is no supplemental power, the micro-solar array 12 continues to provide power to the load device 18 in step 82. If there is supplemental power it is used in step 88 to charge the battery 16 and provide power to the load device 18 in step 82. When the load device 18 is removed the battery 16 is charged until full in the above-described steps.

Turning now to FIG. 7, there is shown a flowchart depicting the steps used for the sequence of programming instructions which may be used for charging the battery utilizing an external charger 14. As shown in FIG. 7, the microprocessor 10 when no activity is present is in a standby mode in step 50 and checks to see if a time “T” has expired in a continuous loop from step 52 to step 50. When time “T” has expired in step 52 the microprocessor 10 checks the condition in step 78 whether the battery 16 is fully charged. If the battery is fully charged, the microprocessor 10 returns to step 50 in standby mode and the cycle begins again. If in step 78, the battery is not full the sequence proceeds to step 92 wherein the battery management logic determines if power is available from an external charger 14 in step 92. If no power is available, the microprocessor 10 returns to standby mode in step 50 and the process begins again. Referring once again to FIG. 7, if there is power available from the external charger 14 in step 92, the sequence proceeds to step 94 wherein the microprocessor 10 checks to see if the there is a load device 18 present. If no load device 18 is present, the battery 16 is charged in step 100 by the external charger 14 and the sequence proceeds to step 78 and loops through steps 78, 92, 94 and 100 until the battery 16 is fully charged or power is no longer available for charging from the external charger 14. If there is a load device in step 94, the external charger supplies power to the load device 14 in step 96 and charges the battery 98 until the load device in step 94 is removed and the above-mentioned steps complete the charging of the battery 16.

It should be understood that with respect to FIGS. 3 through 6 except for the presence of the charger that in standby mode 50 all conditions are checked concurrently and that when any one condition results in going into standby mode 50, the microprocessor 10 will place the solar battery 15 for any sequence of flowcharts into standby mode.

While the invention has been particularly shown and described with reference to a preferred embodiment, it will be understood by those skilled in the art that various changes in form and detail may be made therein without departing from the spirit and scope of the invention:

What is claimed is:

1. A solar battery comprising:
control means for monitoring power availability from a solar battery and repetitively executing a sequence of program instructions for implementing solar battery management.

2. The solar battery according to claim 1, further comprises:
a solar source connected to a battery through said control means.

3. The solar battery according to claim 2, wherein said control means for monitoring power availability from a solar battery further comprises:
a predetermined load demand for determining power availability from said solar source.

4. The solar battery according to claim 2, wherein said control means for monitoring power availability from a solar battery further comprises:
a predetermined load demand for determining power availability from said battery.

5. The solar battery according to claim 2, wherein said control means for monitoring power availability from a solar battery further comprises:
load demand input for determining power availability from said solar source.

6. The solar battery according to claim 2, wherein said control means for monitoring power availability from a solar battery further comprises:
load demand input for determining power availability from said battery.

7. The solar battery according to claim 5, wherein said control means for repetitively executing a sequence of program instructions for implementing solar battery management further comprises:
power delivery to said load demand input from said solar source.

8. The solar battery according to claim 6, wherein said control means for repetitively executing a sequence of program instructions for implementing solar battery management further comprises:
power delivery from said battery based on load demand input.

9. The solar battery according to claim 2, wherein said control means for repetitively executing a sequence of program instructions for implementing solar battery management further comprises:
memory for permanently storing battery management information when there is no power availability from said solar source and said battery.

10. The solar battery according to claim 2, wherein said control means further comprises:
a logic circuit for choosing said power available between said solar source and said battery.

11. The solar battery according to claim 10, wherein said control means further comprises:
a logic circuit for choosing said power availability based on a voltage determination for a load.

12. The solar battery according to claim 2, wherein said control means for repetitively executing a sequence of program instructions for implementing solar battery management further comprises:
memory for continuously obtaining and storing charge information for said battery.

13. The solar battery according to claim 2, wherein said control means for repetitively executing a sequence of program instructions for implementing solar battery management further comprises:
memory for continuously obtaining and storing voltage information for said battery.

14. The solar battery according to claim 2, wherein said control means for repetitively executing a sequence of program instructions for implementing solar battery management further comprises:
memory for continuously obtaining and storing discharge information for said battery.

15. The solar battery according to claim 2, wherein said control means for repetitively executing a sequence of program instructions for implementing solar battery management further comprises:
memory for continuously obtaining and storing “n” charge cycle information for said battery.

16. The solar battery according to claim 2, wherein said control means for repetitively executing a sequence of program instructions for implementing solar battery management further comprises:
memory for continuously obtaining and storing temperature information for said battery.

17. A solar battery comprising:
implementing solar battery management utilizing a microprocessor for providing power to a load device based on power availability and delivery from a solar battery.

18. The solar battery system according to claim 17, further comprising:
connecting a solar source to a battery through said microprocessor

19. The solar battery according to claim 18, further comprising:
determining power availability from said solar source based on a predetermined load demand.

20. The solar battery according to claim 18, further comprising:
determining power availability from said battery based on a predetermined load demand.

21. The solar battery according to claim 18, further comprising:
determining power availability from said battery based on a load demand input.

22. The solar battery according to claim 18, further comprising:
determining power availability from said solar source based on a load demand input.

23. The solar battery according to claim 18, further comprising:
implementing solar battery management utilizing power from said solar source.

24. The solar battery according to claim 18, further comprising:
implementing solar battery management utilizing power from said battery.

25. The solar battery according to claim 18, further comprising:
permanently storing battery management information when there is no power availability from said solar source and said battery.

26. A solar battery comprising:
a solar source connected to a battery through a microprocessor for monitoring power availability from a solar source and said battery for repetitively executing a sequence of program instructions for implementing solar battery management and having memory for permanently storing battery management information when there is no power availability from said solar source and said battery.
